(19) United States
(12) Patent Application Publication
(10) Pub. No.: US 2010/0277320 A1
(43) Pub. Date: Nov. 4, 2010

(54) RFID Keypad Assemblies

(76) Inventor: Steven K. Gold, Lexington, MA (US)

Correspondence Address: ROBERT PLOTKIN, PC, 15 New England Executive Office Park, Burlington, MA, 01803, US

(21) Appl. No.: 12/816,511

(22) Filed: Jun. 16, 2010

Related U.S. Application Data
(60) Provisional application No. 61/221,618, filed on Jun. 30, 2009.

(51) Int. Cl. G08B 13/14

(52) U.S. Cl. 340/572.1

(57) ABSTRACT

The present invention relates to RFID keypad assemblies and, more particularly, to embodiments of RFID keypad assemblies having two or more keys, such as keys that are depressible by a person's finger, each key being associated with a RFID transmitter and capable of enabling the transmitter to transmit a signal that may be read by a compatible RFID reader. Activation of a key may, depending on the embodiment, either enable or disable transmission of any particular RFID transmitter with which it is associated. This provides a RFID keypad assembly that may be made and used as a wireless communication device. Examples of practical applications for a RFID keypad assembly include, but are not limited to: confirming an identity, controlling an object, and requesting a service. Embodiments of RFID keypad assemblies of the present invention may include any of a wide range of variations to enable their use for a diversity of practical consumer, commercial and industrial applications.

### CROSS-REFERENCE TO RELATED APPLICATIONS

This application claims priority from co-pending and commonly owned U.S. Prov. Pat. App. Ser. No. 61/221,618, filed on Jun. 30, 2009, entitled, “RFID Keypad Assemblies.”

### BACKGROUND

Radio frequency identification (RFID) relates to systems and methods used to facilitate the identification of objects (including people). A RFID tag (also called a “transponder” or “transmitter”) may be attached to an object, and may be read by a RFID tag reader (also called a “reader” or “interrogator”). Many RFID tag and reader products and technologies are available to address a variety of practical applications.

A RFID tag is an object that uses electromagnetic energy (e.g., radio waves) to transmit a signal to a RFID tag reader when the tag is within range of a compatible reader. Different RFID systems operate at different frequencies, and the frequency and other factors determine the range of a particular system (distances at which a tag may be read by a reader of a particular RFID system). In general, a few frequencies in use for RFID systems include radio frequencies (about 30 KHz to about 300 GHz), such as, for example, low-frequency (around 125 KHz), high-frequency (13.56 MHz), and ultra-high-frequency or UHF (860-960 MHz)). Microwave (2.45 GHz) is also used for some RFID applications. One reason for the use of different frequencies for different RFID applications is because each frequency has different characteristics. For example, low frequency systems include tags that use less power and are better at penetrating non-metallic materials (e.g., fruit), however these tags can generally only be read at a range of up to a third of a meter away from a reader. High frequency tags are better for use with metal objects and have a read range of about one meter. Ultra High Frequency (UHF) tags provide even better range and faster data transfer rates, however they use more power and are less capable of transmitting signals through certain materials. In summary, different RFID systems operate at different frequencies and provide unique sets of operating characteristics that favor certain applications.

Many of today's RFID tags include an integrated circuit (e.g., silicon chip) used for storing and processing information, modulating and demodulating a signal, and other functions, coupled to an antenna used to transmit a signal. RFID tags that include a power source (e.g., battery) are called “active” RFID tags, and those that do not include a power source (e.g., battery) are called “passive” RFID tags. Semi-active RFID tags (e.g., battery assisted, also known as semi-passive RFID tags) and beacon RFID tags (those capable of transmitting a signal autonomously) also exist. Another type of RFID tag, the “chipless” RFID tag, is likely to play an increasing role in the future. With the advent of printable circuit technology, RFID tags that are printable directly onto surfaces of (or embeddable within) objects have become a reality.

Printed and chipless RFID tags provide low cost and versatility, and they are likely to become more and more desirable for certain consumer, commercial and industrial object identification applications. It is estimated that chipless RFID tags will dominate the market for RFID tags within the next ten years, with the production of more than a quarter trillion tag units per year by the year 2018 (Source: Printed and Chipless RFID Forecasts, Technologies and Players 2008-2018, by Raghu Das and Peter Harrop, published by IDTechEx, 2008). Several chipless RFID tag technologies are in development, including those that use nanometric particles with varying magnetic properties in order to create a device that can resonate and emit a distinct signal at close range, as well as chipless RFID tags that may be read at greater range.

RFID tags are read by RFID tag readers. RFID tag readers, in general, are capable of receiving signals from multiple compatible RFID tags that are located within the reception range of the particular RFID tag reader system, and that are consistent with the signal reception parameters of the particular RFID tag reader system. RFID reader systems vary, depending on their particular application and the RFID tags that they are intended to read. Furthermore, RFID tag readers are typically connected to some form of information processing system (e.g., computer hardware, software), which may be networked and may also include a database. Such information processing system may be used, for example, to process tag signals to provide useful (e.g., actionable) information. For example, such information processing system may associate specific RFID tag signal data with a particular object, and inform an operator or system whether or not such object is present or absent within a particular physical space based on whether or not specific RFID tag signal data is detected by a particular RFID tag reader. Such systems are commonly used for object tracking and inventory management applications. RFID tag and reader systems, along with their associated information processing systems, vary widely in order to accommodate a wide range of consumer, commercial and industrial applications.

A few examples of current RFID applications include: inventory management, manufacturing process component tracking and process optimization, consumer packaging, pharmaceutical packaging, tracking people, tracking livestock, pet identification, shipping container management, luggage processing, etc.

One benefit of RFID technology is that RFID tags may be read “wirelessly” by RFID tag readers through the use of radio waves, versus printed bar code technology that requires line-of-sight bar code readers. Another benefit of RFID systems is their ability to read many distinct RFID tags quickly. RFID systems may also be designed to read tags that are either nearby, or at a significant distance. Such versatility makes RFID systems useful for identification and tracking of a wide range of objects. As RFID technology becomes more cost effective, it is anticipated that RFID tags and RFID tag readers will become more commonplace, and will enable a range of new and useful applications of the basic technology.

### SUMMARY

The present invention relates to RFID keypad assemblies and, more particularly, to embodiments of RFID keypad assemblies having two or more keys, such as keys that are depressible by a person's finger, each key being 100

with a RFID transmitter and capable of enabling the transmitter to transmit a signal that may be read by a compatible RFID reader. Activation of a key may, depending on the embodiment, either enable or disable transmission of any particular RFID transmitter with which it is associated. This provides a RFID keypad assembly that may be made and used as a wireless communication device. Examples of practical applications for a RFID keypad assembly include, but are not limited to: confirming an identity, controlling an object, and requesting a service. Embodiments of RFID keypad assemblies of the present invention may include any of a wide range of variations to enable their use for a diversity of practical consumer, commercial and industrial applications.

### BRIEF DESCRIPTION OF THE DRAWINGS

FIG. 1A shows a front view of an embodiment of the present invention.

FIG. 1B shows a side view of the embodiment of the present invention shown in FIG. 1A.

FIG. 2A shows a front detail view of elements of an embodiment of the present invention represented by item 100′ shown in FIG. 1A.

FIG. 2B shows a side detail view of elements of an embodiment of the present invention represented by item 100″ shown in FIG. 1B.

FIG. 3A shows a representation of a first possible key-transmitter-signal configuration of an embodiment of the present invention.

FIG. 3B shows a representation of a second possible key-transmitter-signal configuration of an embodiment of the present invention.

FIG. 3C shows a representation of a third possible key-transmitter-signal configuration of an embodiment of the present invention.

FIG. 3D shows a representation of a fourth possible key-transmitter-signal configuration of an embodiment of the present invention.

FIG. 4A shows a representation of a first possible system of the present invention.

FIG. 4B shows a representation of a second possible system of the present invention.

FIG. 5 shows a table representing possible database entries.

FIG. 6A shows a first possible representation of a key actuation-signal transmission relationship.

FIG. 6B shows another possible representation of a key actuation-signal transmission relationship.

FIG. 6C shows yet another possible representation of a key actuation-signal transmission relationship.

FIG. 6D shows yet another possible representation of a key actuation-signal transmission relationship.

FIG. 6E shows yet another possible representation of a key actuation-signal transmission relationship.

FIG. 6F shows yet another possible representation of a key actuation-signal transmission relationship.

FIG. 6G shows yet another possible representation of a key actuation-signal transmission relationship.

FIG. 6H shows yet another possible representation of a key actuation-signal transmission relationship.

FIG. 6I shows yet another possible representation of a key actuation-signal transmission relationship.

FIG. 6J shows yet another possible representation of a key actuation-signal transmission relationship.

FIG. 7 shows a front view of an embodiment of the present invention.

FIG. 8 shows a front view of another embodiment of the present invention.

FIG. 9 shows a front view of yet another embodiment of the present invention.

FIG. 10 shows a front view of yet another embodiment of the present invention.

FIG. 11A shows a representation of a possible embodiment of a method of the present invention.

FIG. 11B shows a representation of another possible embodiment of a method of the present invention.

FIG. 12A shows a representation of another embodiment of a method of the present invention.

FIG. 12B shows a representation of yet another embodiment of a method of the present invention.

### DETAILED DESCRIPTION

The present invention relates to RFID keypad assemblies. Embodiments of RFID keypad assemblies of the present invention include a keypad having two or more keys. In one embodiment, each key of an RFID keypad is an element that, when activated (e.g., touched or depressed by means of a user's finger), enables an associated RFID transmitter (signal transmission means) to transmit a distinct signal that is then capable of being received by a compatible RFID reader (or any radio or wireless receiver capable of detecting such signal). Such a distinct signal, or a collection of such distinct signals, once received by a compatible RFID reader (i.e., receiver), may be processed by an information processing system in order to facilitate or cause some action, which may be predetermined, for example.

As noted previously, a RFID tag or transmitter is a signal transmission means that uses electromagnetic energy (e.g., radio waves) to transmit a signal to a compatible RFID tag reader or receiver when the tag is located within range of such a reader. Different RFID systems operate at different frequencies, and the frequency and other factors determine the operational characteristics of a particular system. In general, a few frequencies in use for RFID systems include low-frequency (around 125 KHz), high-frequency (13.56 MHz), and ultra-high-frequency or UHF (860-960 MHz). Microwave (2.45 GHz) tags are also used for some RFID applications. Each frequency offers different system characteristics. Many of today's RFID tags (transmitters) include an integrated circuit (e.g., silicon chip) to store and process information, modulate and demodulate signals, and other functions, coupled to an antenna. RFID tags that include a power source (e.g., battery) are called “active” RFID tags, and those that do not include a power source (e.g., battery) are called “passive” RFID tags. Semi-active RFID tags (e.g., battery assisted, also known as semi-passive RFID tags) and beacon RFID tags (those capable of transmitting a signal autonomously) also exist. RFID transmitters may also be printed. RFID tags may also be chipless. In general, RFID tags are thin (e,g., less that 2.0 millimeter) and small (e.g., no more than 50 millimeters in one or more dimensions, including antenna), although other (including newer) RFID tags may be much thinner and smaller, including one RFID tag made by Hitachi that measured approximately 0.05 millimeters long by 0.05 millimeters wide, excluding an antenna (which is challenging to attach to such small tags). An example of a specific RFID tag is the “3M RFID Tracking Tag” which is less than 1.0 millimeter in thickness, 45 millimeters in length, 45 millimeters in width (including its antenna), is passive, and operates at 13.56 MHz. In addition, this particular tag includes a preprogrammed (assigned) factory ID and includes 256 bits of programmable read-write memory, with an estimated 100,000 write cycles and unlimited read cycles.

Notably, although RFID tags and transmitters are referred to as Radio Frequency Identification (RFID) devices, they may transmit at frequencies that are outside of the frequency range that is normally associated with the “radio” frequency range. In addition, it is anticipated that despite the reference to RFID in this disclosure, other names may be applied to these and similar technologies (which are often grouped together). It is also anticipated that other miniature, inexpensive technologies, including but not limited to Surface Acoustic Wave (SAW) technology and devices and Optical RFID (OPID) technology and devices, for example, may be used in a manner described in the present disclosure, i.e., to provide a keypad assembly made of one or more signal transmission means that are capable of wirelessly communicating information between the device and a compatible reader or receiver. The term “RFID” is used herein to apply to all such technologies.

In general, embodiments of RFID keypad assemblies 1 of the present invention are associated with (e.g., made in combination with, built onto, integrated with, or attachable to) an object 2. Examples of objects include, but are not limited to: a plastic card, credit card, identification card, security card, key card, key, casing, box, bag, envelope, container, piece of paper or cardstock, file folder, sheet of material, fabric, item of clothing, wrist band, or any other structure that is capable of retaining the individual elements of an embodiment of the present invention. Many such structures may be portable, e.g., capable of being moved, carried or worn by a person. Embodiments of RFID keypad assemblies 1 of the present invention may include a keypad 5 having two or more keys 10. An individual key 10 may be a physical element or a virtual (“soft”) key, for example. A key 10 may be actuated by a human action, such as depressing key 10 with a finger, for example. Other methods of actuation may also be possible. Each key 10 is associated with a RFID transmitter 20 (signal transmission means) capable of producing a distinct signal 25.

A key 10 may be associated with a RFID transmitter 20 by means of a connector 15, using either direct or indirect contact. Connector 15 may be mechanical or electrical means, for example, such as a physical spacing means, or electrical circuit or switch, respectively. In one possible embodiment, actuation of key 10 enables an associated RFID transmitter 20 to transmit a signal 25. Such transmission of signal 25 may be either immediate or delayed, for example. Signal 25 transmission may also have a duration that is the same as the duration of time an associated key 10 is depressed (or otherwise triggered), or signal 25 duration may be prolonged, or caused to last for a pre-specified period of time. In one embodiment, a relationship between actuation of a key 10 and enablement of a related signal 25 transmission may also vary or be manipulated in other ways (possibly by means of a microprocessor or chip), including but not limited to: delays between key 10 actuation and enablement of signal 25 transmission; differences between the duration of key 10 actuation and duration of actual related signal 25 transmission; signal 25 transmission that continues or is sequential or concurrent relative to transmission of other signals; and possible repetition of signal 25 transmission for a fixed number of repetitions or for a specified period of time, for example. These various relationships may be designed and built (e.g., programmed) into a RFID keypad assembly 1 of the present invention to enable one or more keys 10 to be actuated and to then enable signal 25 transmission (or cessation of signal 25 transmission) in a manner that allows for the use of such RFID keypad assembly 1 of the present invention in a manner that allows for such assembly to be moved from a first position that conveniently allows a user to actuate individual keys 10 on keypad 5 (e.g., in front of a user's body), to a second possibly different position that is within range of a RFID tag reader capable of receiving one or more signals 25 from such an assembly 1 of the present invention (e.g., held or moved in close proximity to a RFID tag reader 30), for example. In other words, various embodiments of the present invention may include a key actuation-signal transmission relationship that uses one or more of a delayed, prolonged, sequential, concurrent or repeated transmission of one or more signals 25. This may be useful for certain applications of the present invention to enable a user to provide input while positioning (e.g., holding) a RFID keypad assembly 1 in a first position, and then moving the same RFID keypad assembly 1 to a second position (e.g., within reading range close to a RFID tag reader 30) so that one or more signals 25 may be received by a RFID tag reader 30 or another type of compatible receiver, for example. In such a case, signal 25 transmission may time-out after a period of time so that whatever information was input using keypad 5 could be encoded and transmitted to a nearby RFID tag reader 30 or receiver, and then such information would, in one embodiment, cease to be wirelessly communicated and also not retained in memory. Such a RFID keypad assembly 1 of the present invention could be used to securely transfer an access code from a user's mind to the assembly, and from the assembly to a compatible reader (e.g., to enable access to a secure area), before timing out and becoming undetectable. Notably, although embodiments of the present invention are described in terms of enablement of signal 25 transmission following key 10 actuation, other embodiments of the present invention may cause transmitter to disable signal 25 transmission following key 10 actuation.

In one embodiment of the present invention, a RFID transmitter 20 is a signal transmission means that may wirelessly transmit at least one distinct signal 25. Two signals are “distinct” from each other if they differ from each other in any one or more of their transmission parameters or characteristics. A distinct signal 25 may, for example, provide or be associated with a unique Electronic Product Code (EPC). In this case, a first signal may provide or be associated with a first EPC, and a second signal may provide or be associated with a second EPC which differs from the first EPC, in which case the first and second signals are distinct from each other. As another example, a distinct signal 25 may include or relate to a Global Individual Asset Identifier (GIAI). In this case, a first signal may provide or be associated with a first GIAI, and a second signal may provide or be associated with a second GIAI which differs from the first GIAI, in which case the first and second signals are distinct from each other.

A first signal 25 transmitted by a first RFID transmitter 20 may, for example, be distinct from other signals capable of being transmitted by the same or other RFID transmitters. Other RFID transmitters may, for example, include RFID transmitters (e.g., RFID tags) associated with the same unit (e.g., a particular RFID keypad assembly 1) as that associated with the first RFID transmitter. If a particular embodiment of RFID transmitter 20 is an active RFID tag or device, for example, then actuation of an associated key 10 may enable RFID transmitter 20 in a manner that causes transmission of an associated RFID signal 25, for example, possibly by powering the transmitter or by causing the transmitter 20 to transmit a signal 25 in another way. If a particular embodiment of RFID transmitter 20 is a passive RFID tag or device, then actuation of an associated key 10 may enable RFID transmitter 20 in a manner that allows it to resonate and transmit a signal 25 in response to an interrogation signal by a compatible passive RFID reader 30, for example, or by enabling the assembly to transmit a signal 25 in some other way. Examples of other techniques for controlling transmission of a passive RFID transmitter device include connecting two operational elements of such a passive RFID transmitter element to each other to enable transmission (e.g., when such elements are not connected to each other such signal transmission does not occur, or vice-versa); or unshielding or otherwise physically enabling a resonant transmission to take place, for example. One possible embodiment provides means for controlling or enabling signal 25 transmission by controlling a connection between a transmitter and its antenna, e.g., coupling a transmitter and its antenna (to enable transmission of a signal), and then decoupling the same RFID transmitter and its antenna (to disable transmission of a signal). An alternative embodiment for means for controlling or enabling signal 25 transmission may include making controlled mechanical or electrical changes to an associated antenna (e.g., one necessary for RFID transmitter 20 transmission of signal 25), for example. Yet another method of controlling signal 25 transmission is manipulation of a tag-associated antenna. Other embodiments of transmission tags and devices may be used to provide RFID transmitter 20 elements for embodiments of RFID keypad assemblies 1 of the present invention. As noted, RFID transmitter 20 is capable of transmitting a distinct RFID signal 25 (e.g., unique relative to other RFID transmitter 20 signals). A RFID signal 25 may be received by a compatible RFID reader 30 that is within reading range of the RFID transmitter 20 (e.g., capable of receiving its signal 25). Furthermore, RFID reader 30 may be associated with an information processing system 40, which may also include a database 50. Information processing system 40 and database 50 may be used to associate a received signal with a meaning or action, for example, and may possibly also help communicate such meaning or facilitate such action. Variations of each of the individual elements of a RFID keypad assembly 1 of the present invention are possible and anticipated by the present invention.

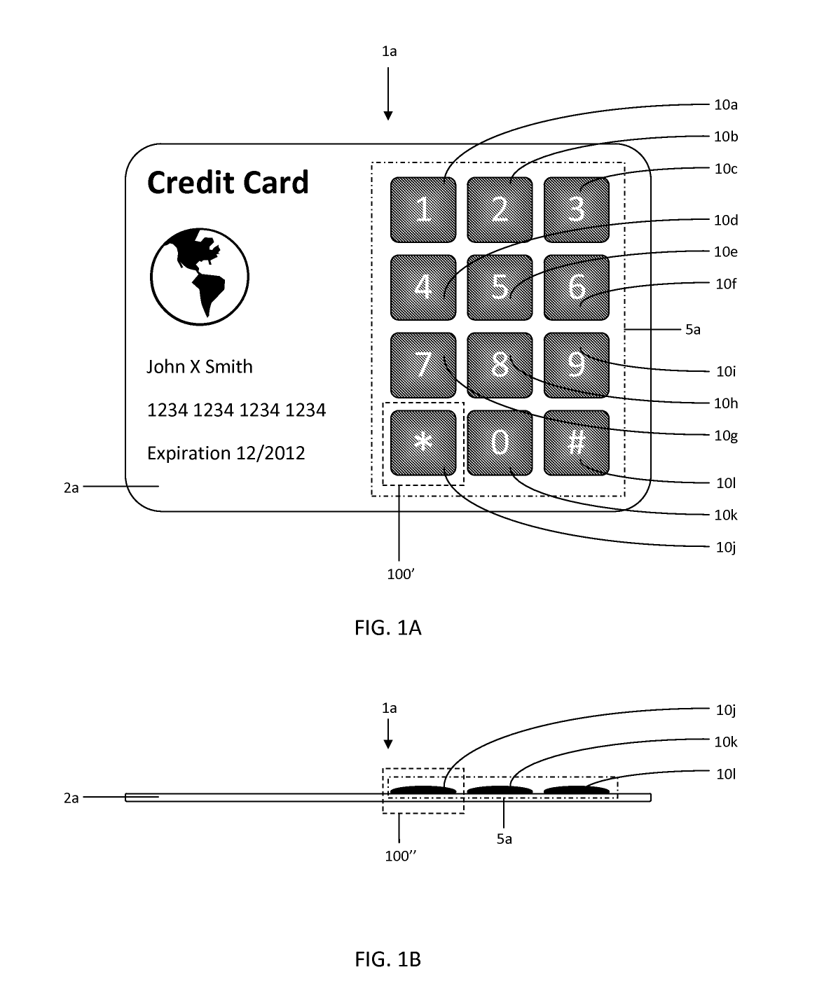

FIG. 1A shows a representative embodiment of a RFID keypad assembly 1a of the present invention in combination with an object 2a that is a credit card (or similar device). Such an embodiment may include a plastic (or other material) object 2a having a keypad 5a built into its front face. The keypad shown in FIG. 1A has twelve keys 10a-l, although other similar embodiments may have another number of keys. While not shown in FIG. 1A, each key of such an embodiment is associated with a RFID transmitter and is also capable of enabling its associated RFID transmitter to transmit a signal. As such, a user may actuate one or more individual keys 10 to cause transmission of one or more signals 25 that may be received by a compatible RFID reader 30 and processed by an information processing system 40. As noted previously, a relationship between key 10 actuation and signal 25 transmission may be one-to-one (meaning that a key 10 actuation correlates with signal 25 transmission or enablement of signal 25 transmission), and may involve delay, prolongation, or repetition of signal 25 transmission (e.g., in the case of an active RFID transmitter 20) or enablement of signal 25 transmission (e.g., in the case of a passive RFID transmitter 30), for example. Such relationship between a key 10 and a RFID transmitter 20 and a signal 25 it produces may be mechanical or electrical in nature, and may possibly include use of a microprocessor or other electrical or other processing means to define or control the relationship.

FIG. 1B shows a side view of the credit card object 2a shown in FIG. 1A. In this drawing, three keys 10j-l are seen in profile, and are slightly raised from the surface of the credit card object 2a. Other key 10 structures, designs and configurations are possible. In this particular embodiment, as shown in FIG. 1B, such keys 10j-l may enable physical depression in a manner that provides tactile feedback to a user.

In general, embodiments of RFID keypad assemblies 1 of the present invention may be used for any of a wide range of practical applications. One example of a possible application is to provide a code entry means to enable an individual to enter a code (e.g., security code consisting of a finite series of numbers or letters, or a combination of these) using keypad 5 at the time of a transaction (e.g., credit or debit card purchase, financial transaction, identity verification transaction, physical space access transaction). Another example of a possible use of an embodiment of the present invention is to provide a RFID keypad assembly 1 that serves as a remote control means that is capable of wirelessly controlling some device or system (e.g., television, stereo, electronic device, lighting system, piece of equipment). Other applications are possible. As such, various embodiments of RFID keypad assemblies 1 of the present invention may be combined or integrated with any of a wide range of objects 2, which may be structures specifically dedicated to encasing or presenting the elements of a RFID keypad assembly 1 of the present invention, or structures that also serve other purposes that may benefit from inclusion of a RFID keypad assembly 1 of the present invention. One example of an object is a generally flat card, such as a credit card, identification card, security card, key card, or other similar card. Another example of an object 2 is a container, whereby an embodiment of a RFID keypad assembly 1 of the present invention may be located on a surface of such a container object 2, for example. Many other objects 2 are possible.

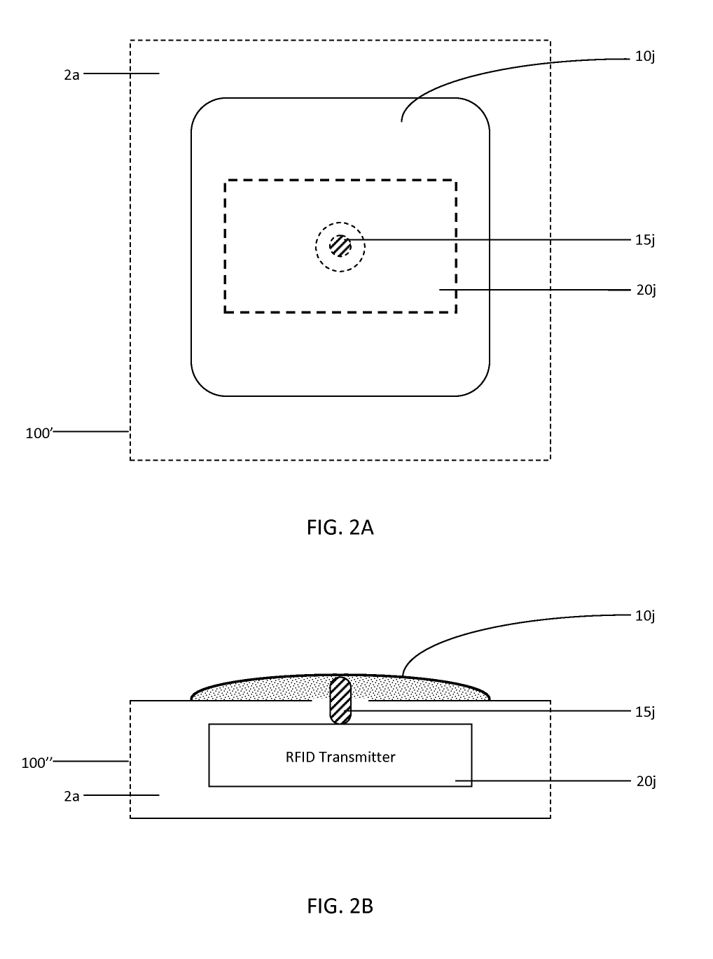

Individual keys 10 may be structures that enable a user to touch them, depress them, or otherwise interact with them to enable an associated RFID transmitter 20 to transmit a signal 25. Keys 10 may be embodied in any of a variety of shapes and sizes, and may also be actuated in any of a variety of ways, e.g., by mechanical force, heat sensing, and other means. Soft keys (e.g., images of keys 10 displayed using a virtual keypad 5 on a touch screen of an electronic device, for example) are also possible, as are soft input means, such as an input field on computer screen or portable electronic device (such input may be processed by such device and would ultimately control one or more RFID transmitters 20). A key 10 may be directly or indirectly connected with an associated RFID transmitter 20. For example, a key 10 may be directly mechanically linked to a RFID transmitter 20 by connector means 15, as shown in FIG. 2A and FIG. 2B. Such connector means may, for example, be a physical structure that transmits a force applied to a key 10 to an associated RFID transmitter 20 in order to enable the RFID transmitter 20 to transmit a signal 25 (in this embodiment, physical force may be translated at the RFID transmitter 20 in order to complete an electrical circuit to cause signal transmission, for example). In other possible embodiments, a key 10 may be linked with an associated RFID transmitter 20 by connector means that are electronic (e.g., key 10 serves as a switch that is connected to the RFID transmitter 20 by wires or other conductive means). As noted, soft keys 10 or other input means are possible, and would be connected to a RFID transmitter 20 by electronic means or circuits, possibly involving a microprocessor executing software, or other electronic processing means, for example. Connector means 15 may also be magnetic, for example. Connector means 15 may also include a microprocessor, integrated circuit, printed circuit or other electronic logic means. Such electronic means, if used in an embodiment of a RFID keypad assembly 1 of the present invention, may possibly control the relationship between key 10 actuation and RFID transmitter 20 signal transmission. For example, following actuation of a key 10, associated signal 25 transmission may be immediate, concurrent, delayed, prolonged, sequential, repeated or overlapping, or combinations of these, for example. A microprocessor (possibly including and/or operating in conjunction with a memory) or other control means may enable control of this key actuation-signal transmission relationship, and may also control or enable other processes.

Each RFID transmitter 20 is associated with one or more keys 10. RFID transmitter 20 may be a passive RFID transmission device, battery-assisted RFID transmission device, fully active RFID transmission device, or other type of RFID transmission device. RFID transmitter 20 may be printed. RFID transmitter 20 may be chipless. In embodiments of RFID keypad assemblies 1 of the present invention, each RFID transmitter 20 is capable of transmitting at least one distinct RFID signal 25, meaning a signal 25 that is readable by a compatible RFID reader 30 that is within reception range of the particular RFID keypad assembly 1 of the present invention. The RFID signal 25 transmitted by a particular RFID transmitter 20 may be distinct from other signals transmittable by the same transmitter 20 and/or distinct from signals transmittable by other transmitters 20. Transmission of signals 25 produced by RFID keypad assemblies 1 of the present invention may be used to wirelessly communicate with RFID readers 30 (including RFID reader networks). Such communication may enable RFID keypad assemblies 1 of the present invention to be used for identity verification, remote control of devices, and wireless communication, for example. Variations in embodiments of RFID keypad assemblies 1 of the present invention are possible, including variations in assembly elements and components, and assembly processes and practical applications. For clarity, in a preferred embodiment of RFID keypad assembly 1 RFID transmitter 20 communicates with a RFID reader over the air using electromagnetic means (e.g., radio frequency signals).

An example of a method of using a RFID keypad assembly 1a of the present invention may involve, for example, positioning a credit card object 2a within reception range of a compatible RFID reader 30 (e.g., at a point of purchase near a cash register), and entering one's personal security code into the credit card object 2a by sequentially depressing keys selected from keys 10a-l. Alternatively, for example, a person may enter personal security information into a credit card object 2a using keys 10a-l, possibly beyond the reception range of a compatible RFID reader 30, and then move the credit card object 2a within reception range of a compatible RFID reader 30 (e.g., at a point of purchase near a cash register). Such action by a user of such a credit card object 2a may enable transmission of signals 25 by one or more object-associated RFID transmitters 20. Transmitted signals 25 may then be received by a RFID tag reader 30 and processed by an information processing system 40 to thereby make a determination, e.g., whether the individual physically possessing the particular credit card object 2a has entered a security code into the credit card object 2a that matches a security code associated with the card object 2a, for example. If so, such information may help determine that the individual physically possessing the credit card object 2a is the rightful owner of the credit card and any related account. Otherwise, a transaction could be denied, or a store clerk could be prompted to seek another form of personal identification to confirm that the individual physically possessing the credit card object 2a is the rightful owner of the credit card and related account. This is just one example of how a particular embodiment of a RFID keypad assembly 1 of the present invention may be used in a particular setting; embodiments of keypad assemblies 1 may be used in other ways depending on their design and intended application.

FIGS. 1A and 1B show details 100′ and 100″ which are shown enlarged in FIGS. 2A and 2B, respectively. FIG. 2A shows a top view of an individual key 10j shown in FIG. 1A. FIG. 2A shows key 10j positioned on a surface of credit card object 2a, and having an associated connector means 15j and associated RFID transmitter 20j, both of which are positioned under key 10j within the structure of credit card object 2a. While this particular embodiment shows an individual key 10j associated with an individual RFID transmitter 20j, other arrangements are possible. FIG. 2B shows a side view of the detail shown in FIG. 2A having key 10j combined with credit card object 2a and associated with connector means 15j and RFID transmitter 20j. In this particular embodiment, key 10j may cause RFID transmitter 20j to transmit a distinct signal. Other designs and key-transmitter configurations and embodiments are possible.

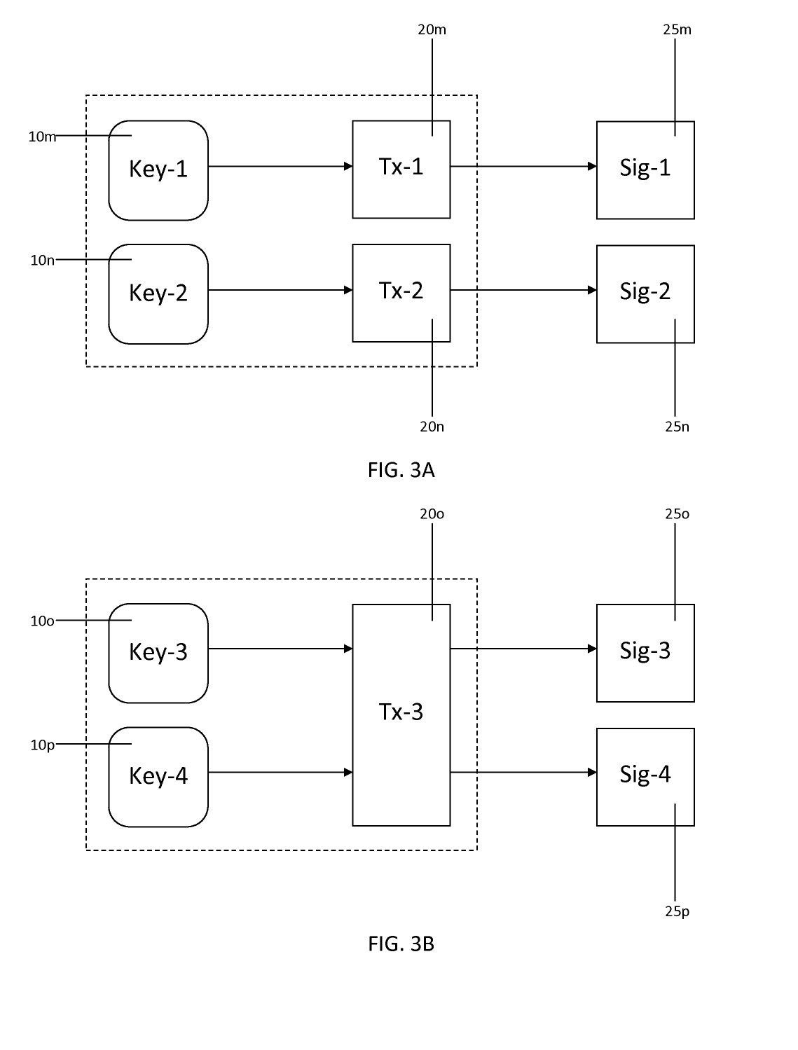

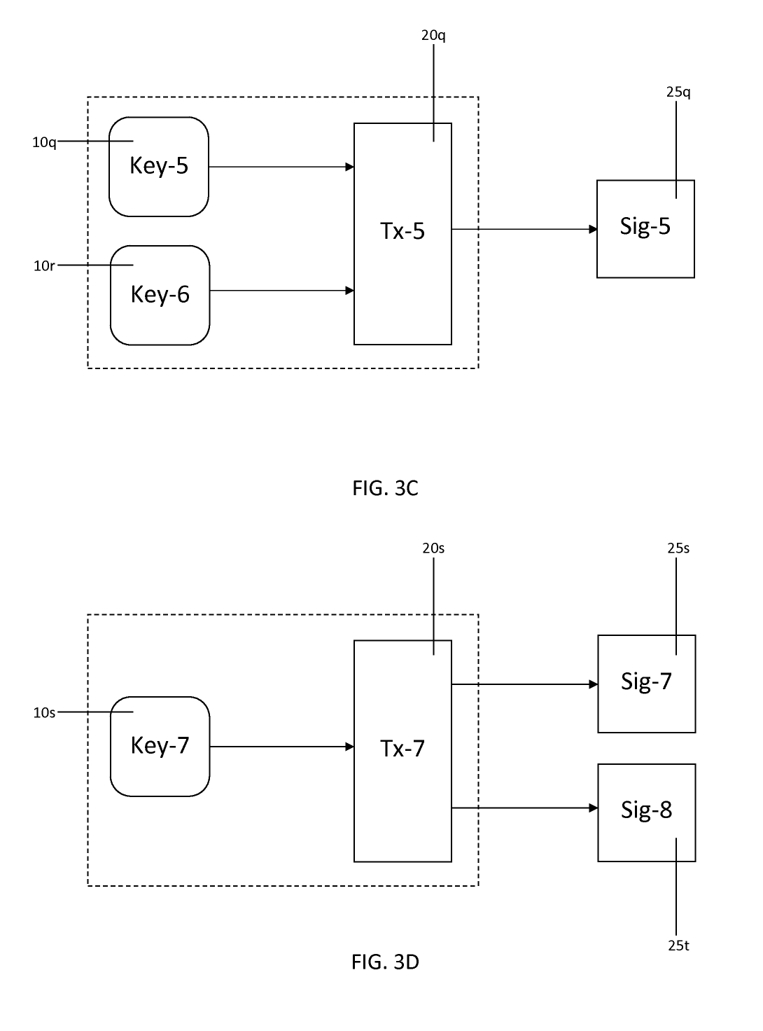

FIGS. 3A-3D show four possible embodiments of relationships between keys 10, transmitters 20, and signals 25. Each of these embodiments shows how one or more keys 10 may relate to one or more transmitters 20 which, in turn, may transmit one or more distinct signals 25. A distinct signal 25 (or absence of a distinct signal 25) communicates information that may be received by a RFID tag reader 30 and processed or interpreted by an information processing system 40.

RFID Keypad Assemblies 1 of the present invention may have individual key 10 actuation-signal 25 transmission relationships implemented in two primary ways. In a first embodiment, actuation of a key 10 may cause signal 25 transmission (in the case of an active RFID tag or transmitter 20, for example) or enable signal 25 transmission (in the case of a resonant-type or passive RFID tag or transmitter 20, for example). In other words, when a key 10 is actuated, a signal from an associated RFID tag or transmitter could be “turned on” and detectable by a compatible RFID reader 30 that is within signal 25 reception range. In a second possible embodiment, actuation of a key 10 may cease signal 25 transmission (in the case of an active RFID tag or transmitter 20, for example) or disable signal transmission (in the case of a resonant-type or passive RFID tag or transmitter 20, for example). In other words, when a key 10 is actuated, a signal 25 from an associated RFID tag or transmitter 20 may be “turned off” and not be detected by a compatible RFID reader 30 that is within signal 25 reception range. Either embodiment of the present invention is capable of communicating information. For example, embodiments of the present invention are anticipated whereby in a RFID keypad assembly 1 made up of multiple keys 10, any particular key 10 may be designed (e.g., engineered, present, operated) such that it will either i) turn on or enable signal transmission, or ii) turn off or disable signal transmission. This is referred to as a “switch” in signal transmission state of a RFID transmitter of the present invention. Notably, a single RFID keypad assembly 1 of the present invention made up of multiple keys 10 may have some keys that turn on or enable signal transmission, and other keys 10 that turn off or disable signal transmission. While a single approach may be preferable for certain embodiments and applications of the present invention (e.g., using a switch in signal transmission state that causes or enables signal transmission during or following key 10 activation), it is also possible to have embodiments and applications of the present invention that communicate information using both approaches concurrently.

FIG. 3A shows a first possible embodiment having two keys 10m and 10n, associated with RFID transmitters 20m and 20n, respectively, which produce distinct signals 25m and 25n, respectively. The transmitters 20m and 20n are different, e.g., physically disjoint, from each other. Such an embodiment may be used to provide a RFID keypad assembly of the present invention with multiple keys, each key associated with its own RFID transmitter that is capable of transmitting its own distinct signal. As such, each key may then (when actuated) directly or indirectly cause transmission of a signal that corresponds to the particular key. FIG. 3B shows a second possible embodiment having two keys 10o-p, both of which are associated with a single (e.g., shared) RFID transmitter 20o which is capable of producing two distinct signals 25o-p depending on which key 10o-p has been actuated. In this particular type of embodiment, a shared RFID transmitter receives a signal (e.g., mechanical, electrical) from a key that has been actuated, and is capable of transmitting a distinct signal for each such key. For example, if Key-3 10o is actuated, then RFID transmitter Tx-3 20o will transmit signal Sig-3 25o; if Key-4 10p is actuated, then RFID transmitter Tx-4 20p will transmit signal Sig-4 25p. Such differential signal transmission may be accomplished by any of a variety of means (e.g., microprocessor or other electronic or other control means or circuits) that enables RFID transmitter 20o to produce multiple, distinct signals 25o-p. An embodiment such as the one shown in FIG. 3B may be useful where a shared transmitter may provide advantages, such as fewer functional components, space savings, or lower cost, for example. FIG. 3C shows a third possible embodiment of a key-transmitter-signal relationship having multiple keys 10q-r associated with a shared RFID transmitter 20q to provide a single signal 25q. Such an embodiment may be useful for RFID keypad assemblies that benefit from having more keys than possible distinct signals. FIG. 3D shows a fourth possible embodiment having a single key 10s associated with a single RFID transmitter 20s that is capable of transmitting multiple distinct signals 25s-t. Such an embodiment may transmit multiple distinct signals based on sequential or differential actuation of key 10s, for example (e.g., depressing a key once vs. twice, for example). For example, a sequential actuation of key 10s may result in a first actuation (e.g., single depression of the key) causing RFID transmitter 20s to transmit Sig-7 25s, and a second (follow-on) actuation of the same key may cause RFID transmitter 20s to transmit Sig-8 25t. An example of differential actuation may be a single actuation of key 10s (e.g., single depression or click of the key) which causes RFID transmitter 20s to transmit Sig-7 25s, and a double actuation of key 10s (e.g., rapid double depression or double-click of the key) which causes RFID transmitter 20s to transmit Sig-8 25t. Such an embodiment enables a single key to transmit multiple distinct signals which may be useful for certain practical applications. In general, as shown in FIGS. 3A-3D, embodiments of RFID keypad assemblies 1 of the present invention may use any of a variety of relationships between keys 10, RFID transmitters 20, and the signals 25 produced or enabled by those tags or transmitters 20, to provide unique functions and other characteristics of a particular embodiment of the present invention. As noted, keys 10 may be hard (e.g., physical) that are, for example, physically depressible by a user, and keys 10 may alternatively be soft (e.g., presented and usable on an interactive electronic display such as a touch screen, for example). Furthermore, in the case of a computer or other electronic device, the concept of a “key” extends to other input means (e.g., plain text entry, graphics that may be manipulated, etc.), wherein such an input means is associated (e.g., connected via electronic means that may include a microprocessor or electronic circuit) with one or more RFID transmitters 20 of the present invention to thereby cause or enable signal 25 transmission. As noted previously, actuation of a key 10 may either turn on/enable transmission of a distinct signal 25, or turn off/disable transmission of a distinct signal 25, capable of being transmitted by a RFID transmitter or tag 20 with which a key 10 is associated. The change of a transmitter 20 from being turned on or enabled to transmit a signal 25, to being turned off or disabled from being able to transmit a signal 25, or vice-versa, is considered a “change” or “switch” in signal transmission state. Furthermore, RFID keypad assemblies 1 of the present invention may include multiple keys 10, and individual keys 10 may use either type of switch in signal transmission state, e.g., may go from on to off, or from off to on. As such, a single RFID keypad assembly 1 of the present invention may include keys 10 (each associated with either the same or a different RFID tag or transmitter 20), each using a different approach to signal transmission, e.g., following actuation, some keys 10 may enable associated signal 25 transmission, and some other keys 10 may disable associated signal 25 transmission. As yet another example, activating one or more of the keys 10 may cause a toggle in the state of the corresponding RFID tag 20. For example, if a particular one of the tags 20 currently is in an on/enabled state, then activating a corresponding one of the keys 10 may cause the state of the tag 20 to switch to an off/disabled state, whereas if the particular one of the tags 20 currently is in an off/disabled state, then activating a corresponding one of the keys 10 may cause the state of the tag 20 to switch to an on/enabled state.

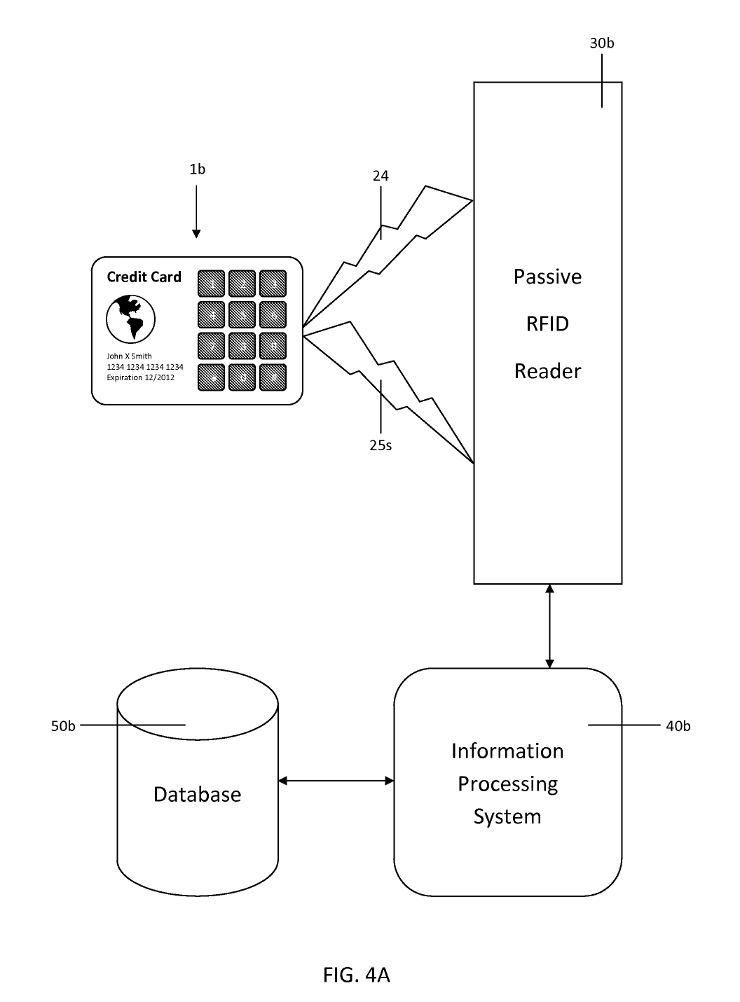

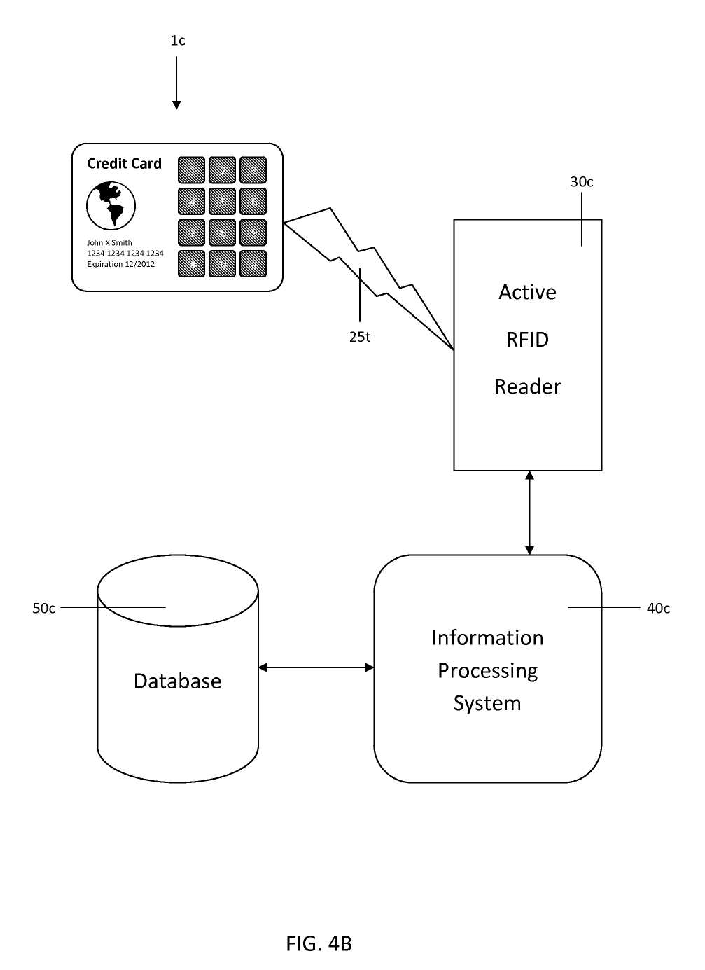

FIG. 4A shows an embodiment of a system of the present invention having a RFID keypad assembly 1b, a compatible passive RFID reader 30b that is capable of transmitting an interrogator signal 24 (e.g., an electromagnetic output that would cause a passive RFID tag to emit a signal) and also receiving signal 25s from a transmitter element of RFID keypad assembly 1b, and an information processing system 40b communicating with a database 50b. In such an embodiment, passive RFID reader 30b may interrogate RFID keypad assembly 1b and, provided that signal 25s is transmitted by RFID keypad assembly 1b (and that RFID keypad assembly 1b is within range of passive RFID reader 30b) RFID reader 30b receives signal 25s. This information (reception of signal 25s) is communicated to information processing system 40b, which communicates with database 50b in this embodiment. FIG. 4A represents how a RFID keypad assembly 1b using a passive RFID transmitter 20 (signal transmission means) may be interrogated and, provided that an associated RFID transmitter has been enabled, transmit a distinct signal 25s that may be received and processed to provide useful information, e.g., which keys of a particular RFID keypad assembly 1b have been actuated by a user (and which have not been actuated).

FIG. 4B shows an embodiment of a system of the present invention having a RFID keypad assembly 1c, a compatible RFID reader 30c that is capable of receiving signal 25t from an non-passive (e.g., active) RFID tag or transmitter 20 (signal transmission means) of the RFID keypad assembly 1c, and an information processing system 40c communicating with a database 50c. In such an embodiment, RFID reader 30c “listens” for compatible transmissions and, provided that signal 25t is transmitted by RFID keypad assembly 1c (and that RFID keypad assembly 1c is within range of RFID reader 30c) RFID reader 30b receives signal 25t. This information (reception of signal 25t) is communicated to information processing system 40c, which communicates with database 50c in this embodiment. FIG. 4B represents how a RFID keypad assembly 1b using active RFID transmission means may transmit a distinct signal 25t that may be received and processed to provide useful information, e.g., which keys of a particular RFID keypad assembly 1c have been actuated by a user (and which have not been actuated).

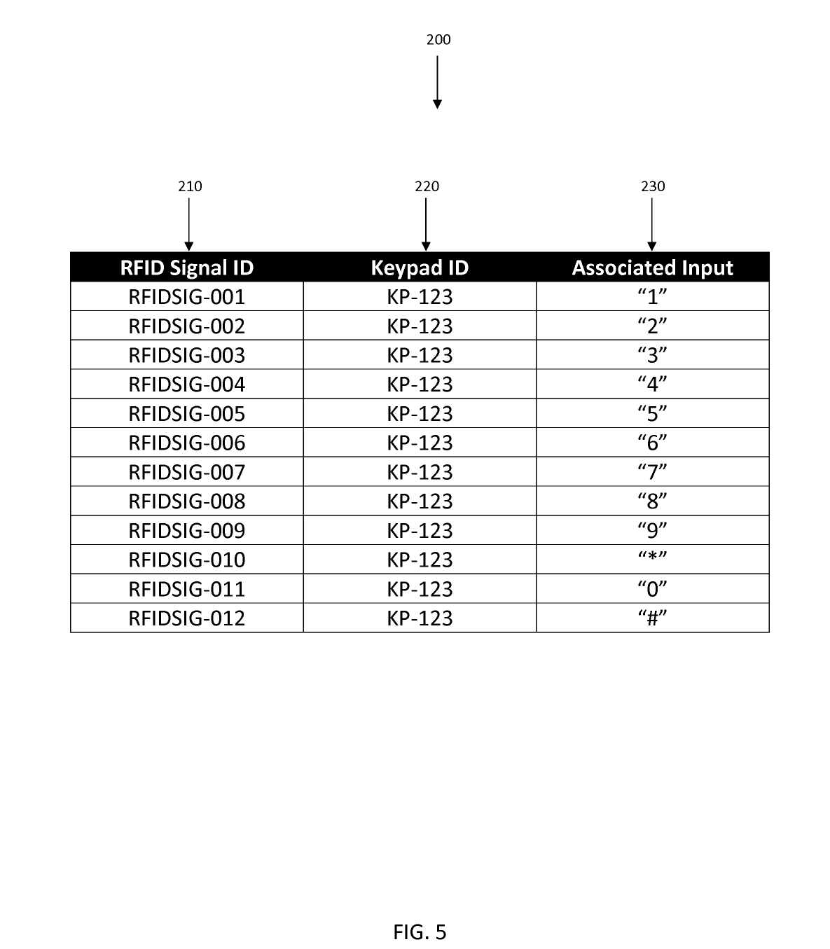

FIG. 5 shows a representation of a possible database table that could be associated with an embodiment of a database 50 of the present invention. Database table 200 includes three fields: RFID Signal ID 210, keypad ID 220 and Associated Input 230. RFID Signal ID 210 represents a signal identifier associated with keypad ID 220 and Associated Input 230 in the same row of database table 200. For example, RFID Signal ID “RFIDSIG-001” is associated with Keypad ID “KP-123” which is associated with Associated Input “1.” This means that the particular RFID Signal ID is being transmitted by a RFID keypad assembly 1 of the present invention having the given Keypad ID, and that the signal 25 represents a particular input. By using a database 50 to correlate distinct signals 25 with a particular input coming from a particular RFID keypad assembly 1, an associated information processing system 40 may make sense of the signal 25 data. For example, an embodiment of a combination credit card and RFID keypad assembly 1 like the one shown in FIG. 1A could enable a user to use a credit card and then use the keypad 5 to enter a code (e.g., 1-2-3) to verify (or contribute to a verification or approval of) an identity, e.g., the identity of the person using the card. In other examples, individual inputs (e.g., a key that is actuated) or a string of inputs may communicate other information. Examples of information that a user may seek to communicate using an embodiment of a RFID keypad assembly 1 of the present invention include, but are not limited to: a code (e.g., security code or personal identification code), a selection (e.g., product or service), a command (increase volume or change a channel), and more. In general, an information processing system 40 having a database 50 may be used to provide translation or understanding relative to the actuation of a particular key 10 that is part of a particular (unique unit of a) RFID keypad assembly 1 and what the actuation means, e.g., what a recipient or information processing system 40 should do with the information, such as facilitate an action or effect a particular command. A variety of database 50 designs, structures and technologies may be used in conjunction with an information processing system 40 of the present invention in order to associate a particular key 10 actuation (and associated transmitted and received signal 25) with a particular action or event. Notably, failure to detect a particular distinct signal 25 or set of signals 25 (the identity of which may be represented in a database 50) may provide information in the same way as detection of a distinct signal 25 provides information, e.g., if at least one distinct signal 25 associated with a particular RFID keypad assembly 1 of the present invention is transmitted and detected, then either the presence or absence of other signals 25 that are associated with the same RFID keypad assembly 1 may convey useful information.

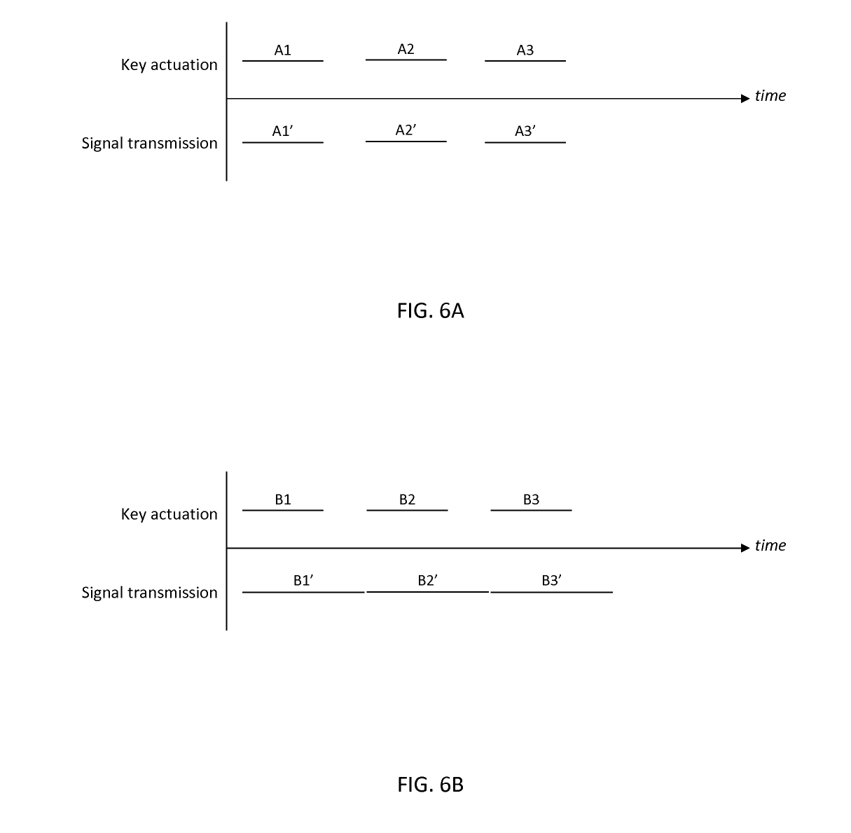

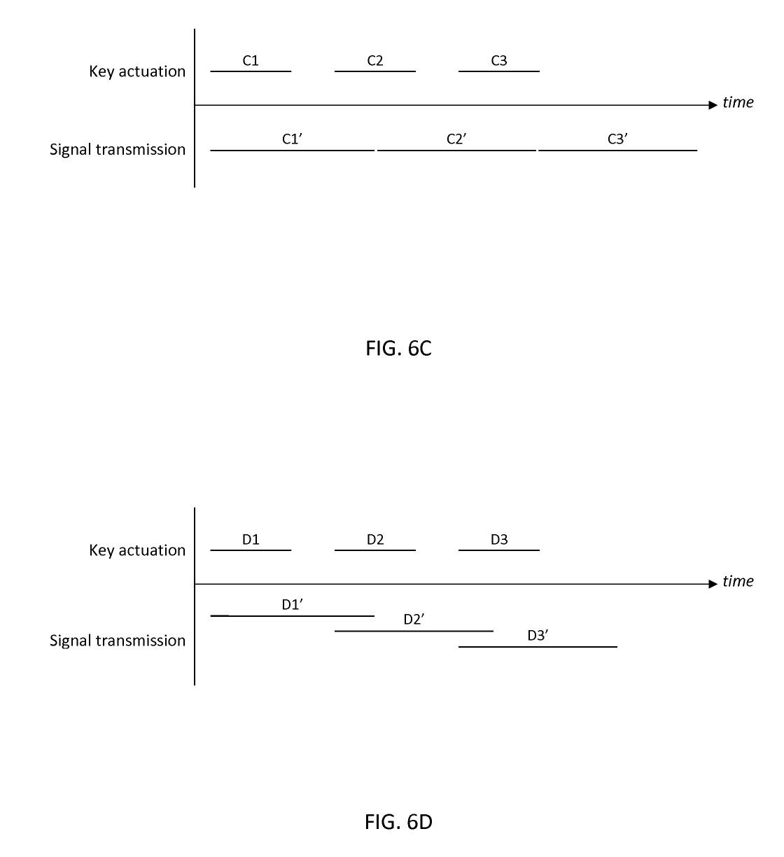

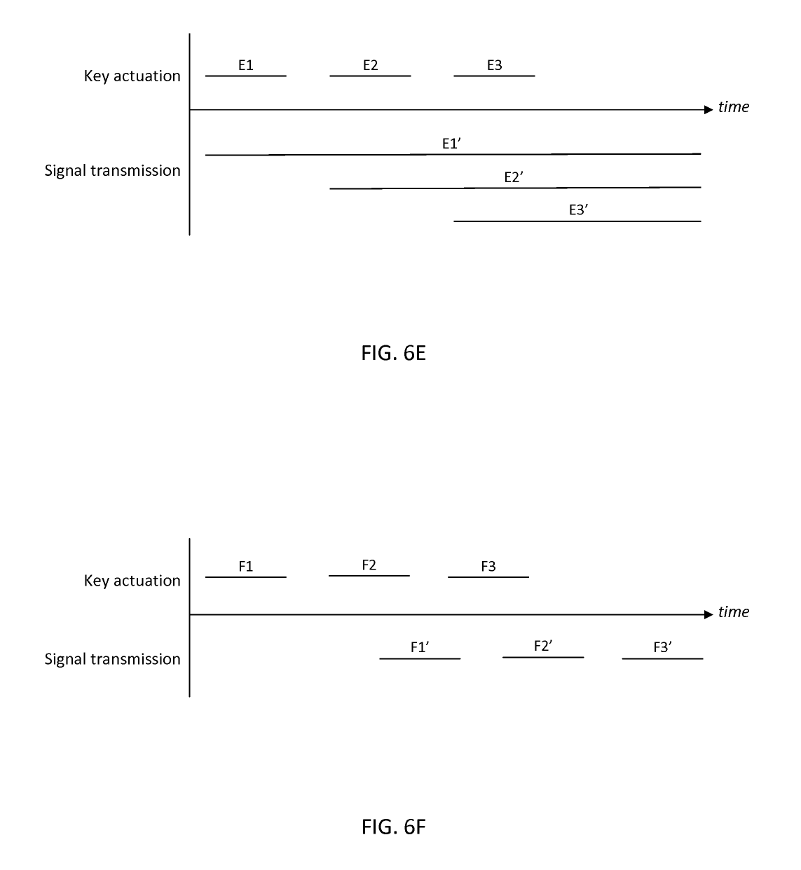

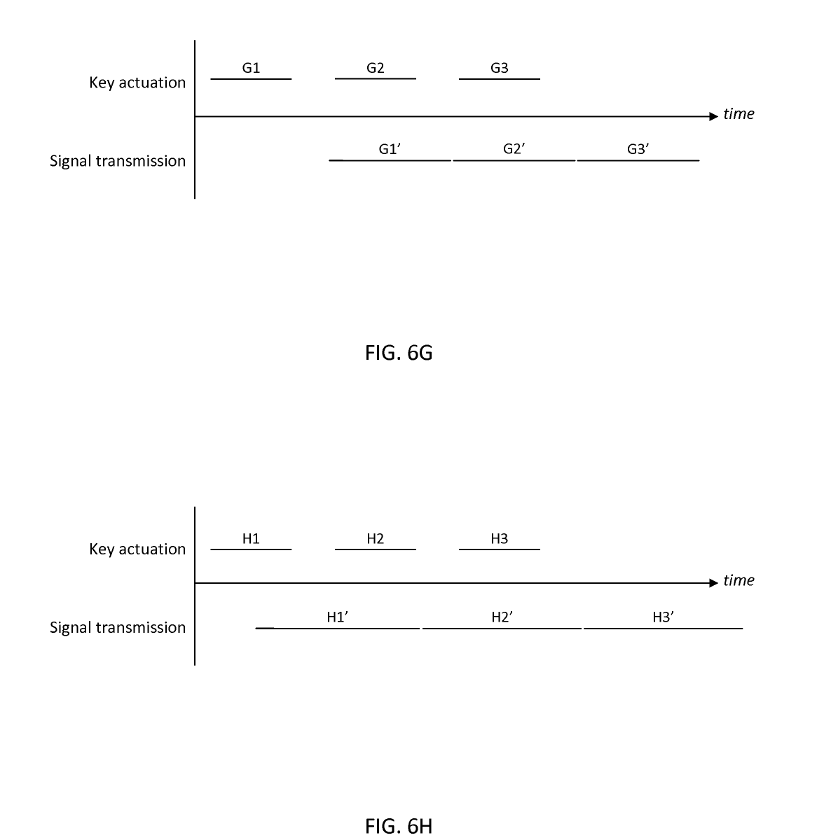

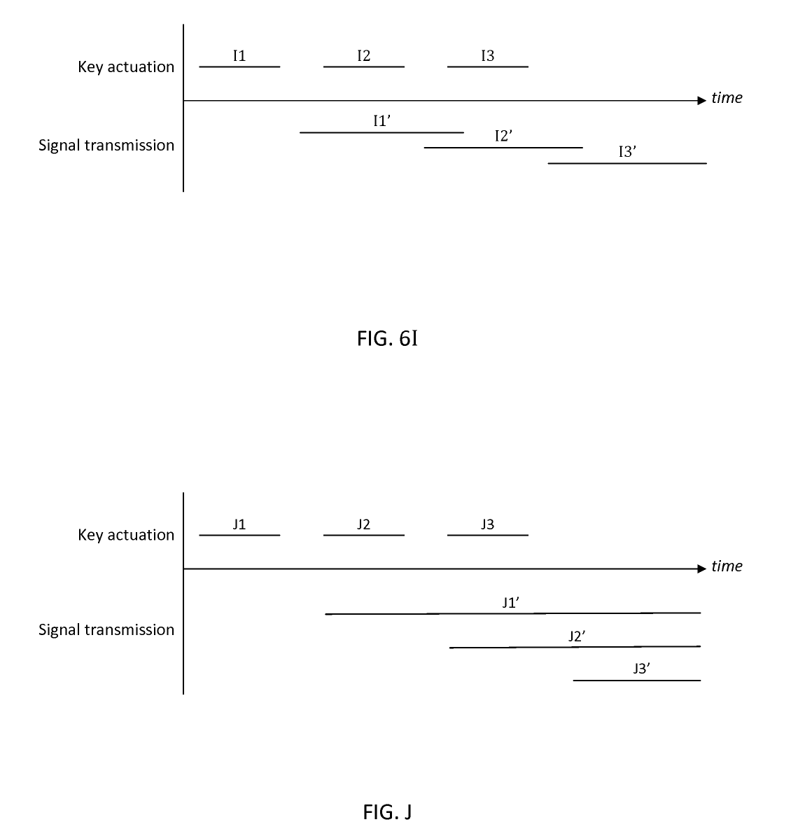

FIGS. 6A-6J show representations of possible relationships between key actuation (e.g., depression of a key by a user of an embodiment of RFID Keypad Assembly 1) of a key 10 of an embodiment of the present invention and associated signal transmission. FIG. 6A shows a first possible embodiment of such a relationship whereby when key A1 is actuated (e.g., depressed), an associated signal A1′ is transmitted only when the key A1 is actuated. Then, when key A2 is actuated, an associated signal A2′ is transmitted only when key A2 is actuated. Finally, when key A3 is actuated, an associated signal A3′ is transmitted only when key A3 is actuated. FIG. 6B shows another possible embodiment of such a relationship whereby when key B1 is actuated (e.g., depressed), an associated signal B1′ is transmitted until a next key is actuated or for a specified duration of time (e.g., 2.0 seconds), whichever comes first. Then, when key B2 is actuated, an associated signal B2′ is transmitted until a next key is actuated or for a specified duration of time, whichever comes first. Then, when key B3 is actuated, an associated signal B3′ is transmitted until a next key is actuated or for a specified duration of time, whichever comes first. Since key B3 is the last key to be actuated in this particular example, signal transmission B3′ will occur for a specified period of time. FIG. 6C shows yet another possible embodiment of such a relationship whereby when key C1 is actuated (e.g., depressed), an associated signal C1′ is transmitted for a specific period of time (e.g., 5.0 seconds) and any next signal is not transmitted until transmission of signal C1′ has ended. Then, following actuation of key C2, an associated signal C2′ is transmitted for a specific period of time (e.g., the same duration as the prior signal) and any next signal is not transmitted until transmission of signal C2′ has ended. Then, following actuation of key C3, an associated signal C3′ is transmitted for a specific period of time (e.g., 5.0 seconds) and any next signal is not transmitted until transmission of signal C3′ has ended. FIG. 6D shows yet another possible embodiment of such a relationship whereby when key D1 is actuated (e.g., depressed), an associated signal D1′ is transmitted for a specified period of time (e.g., 3.0 seconds). Then, when key D2 is actuated, an associated signal D2′ is transmitted for a specified period of time, such transmission possibly overlapping with one or more other transmissions (e.g., signal D1′). Finally, when key D3 is actuated, an associated signal D3′ is transmitted for a specified period of time, such transmission possibly overlapping with one or more other transmissions (e.g., signal D2′). In such an embodiment, signal transmission times may partially or fully overlap. Furthermore, either the multiple individual (distinct) signals, or an aggregated (combined) signal, may be desirable depending on the particular embodiment and intended use. FIG. 6E shows a similar situation to that shown in FIG. 6D, however transmission of each of the signals E1′, E2′, E3′ continues such that all three of these signals come to overlap (be transmitted concurrently), and end at the same time. The ending time may be a pre-specified duration from the time of a first key actuation, for example. FIG. 6F shows a key actuation-signal transmission relationship similar to that shown in FIG. 6A, however each of the signal F1′, F2′, F3′ starting times is delayed by significantly the same period of time. Likewise, FIG. 6G shows a key actuation-signal transmission relationship whereby signals G1′, G2′ G3′ are transmitted sequentially and there is a lag time (period of time) between a first key actuation and the initiation of transmission of the first signal. Similarly, FIGS. 6G and 6H show key actuation-signal transmission relationships resembling those shown in FIGS. 6B and 6C, respectively, except that the initiation of signal first transmissions in FIGS. 6G and 6H are delayed. Finally, FIGS. 6I and 6J show key actuation-signal transmission relationships resembling those shown in FIGS. 6D and 6E, respectively, except that the initiation of signal first transmissions in FIGS. 6I and 6J are delayed. Notably, a key actuation-signal transmission relationship may be varied by virtue of: 1) onset of signal transmission following key actuation (e.g., immediate, delayed by a pre-specified period of time, or triggered by some other event, for example); 2) duration of signal transmission (e.g., duration of key actuation, pre-specified duration, until some other event occurs); 3) sequential or concurrent nature of signal transmission (with concurrent signal transmission being either partial, e.g., partially overlapping, or complete, e.g., completely overlapping), and; 4) repetition, meaning if a set of signals is transmitted either once or repeated multiple times (which may be useful to increase the duration of a particular transmission, possibly to enable a RFID keypad assembly 1 of the present invention to be moved closer to a compatible tag reader or receiver). Other relationship characteristics are also possible.

The preceding examples represented by FIGS. 6A-6J have each used three key 10 actuations and three associated distinct signal 25 transmissions by way of example; these examples are not intended to be limiting as many other key 10 actuation and signal 25 transmission relationships are possible. In general, a key 10 actuation-signal 25 transmission relationship may be achieved by mechanical means (e.g., switch with a built-in delay that keeps a circuit closed for a particular period of time), electronic means (e.g., microprocessor, integrated or printed circuit that applies electronic logic to control the relationship), or other means. Variations of key 10 actuation-signal 25 transmission relationships are possible and may include variations in one or more of the following: the number of relationships (e.g., quantity of key 10 actuations and signal 25 transmissions); timing of interactions; delay between key 10 actuation and associated signal 25 transmission; prolongation of a distinct signal 25 transmission time; overlapping of transmission of distinct signals 25; integration (combination) of signals 25; repetition of a distinct signal 25 or series of distinct signals 25; and more. Key 10 actuation-signal 25 transmission relationships may relate to either type of switch in signal transmissions state. While the examples provided above discuss key actuation leading to signal transmission (or enablement of signal transmission), all of the various relationship possibilities—including any one or more of delay, prolongation, repetition, etc.—may also be applied to the case where a key actuation results in signal transmission (or enablement of signal transmission) being disabled or turned off. A delayed, prolonged absence of a distinct signal may, for example, communicate identical information to a delayed, prolonged reception of a distinct signal. The use of examples applying a switch in signal transmission state that turns on or enables distinct signal transmission does not in any way limit the invention which may be implemented and embodied using either one or both types of switch in signal transmission state in a single RFID keypad assembly 1.

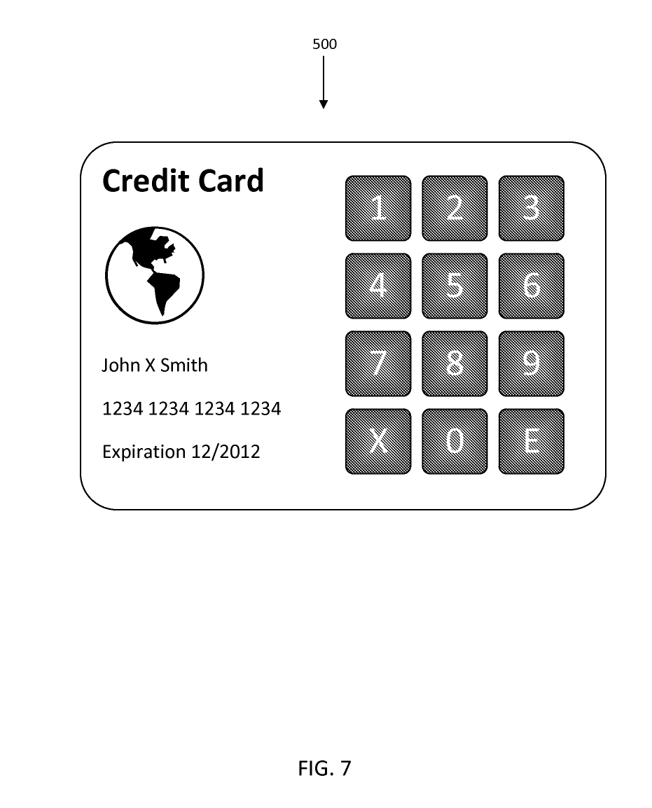

FIGS. 7-10 show four different representative embodiments of RFID keypad assemblies of the present invention that provide examples of various possible uses for embodiments of RFID keypad assemblies of the present invention. In general, the representative devices shown in FIGS. 7-10 provide RFID keypad assemblies that would be used in a RFID enabled environment, meaning an environment (e.g., space or setting) having a RFID reader system that is compatible with the particular embodiments of RFID keypad assemblies being used in that environment, and that is capable of receiving signals that are transmitted by RFID keypad assemblies within the particular environment. For example, an embodiment of a RFID keypad assembly of the present invention combined with a credit card would require (for its functional use) that a compatible RFID reader system be positioned within reception range of the RFID keypad assembly, such as at or near a cash register in a retail store environment, so that the RFID reader system could receive signals being transmitted from the particular RFID keypad assembly being used to help verify an individual's identity during a credit card transaction at that particular cash register.

FIG. 7 shows a front view of a combination credit card and embodiment of a RFID keypad assembly of the present invention 500. The particular embodiment shown in FIG. 7 has a keypad with twelve keys. Such an embodiment may be used, for example, to enable a user to verify his or her identity during a credit card transaction (and may also be used, for example, to enable a retailer or bank or credit card transaction processing entity to verify an identity of a user). In use, this general type of embodiment would allow a user to enter a (secret) personal identification code into a keypad built into the credit card at the time of a transaction. If a retailer has a RFID reader, the code entered into the keypad may be read by the reader and an associated information processing system may be used to determine if a particular code known to be associated with a particular credit card has been entered. If so, this assists in verification of the credit card user. If not, it may provide an indication that the individual physically possessing the card is not the owner of the card. Code matching is done “off the card,” by an information processing system having an associated database, for example. As such, an embodiment of the type shown in FIG. 7 may be used in combination with a credit card to provide a security feature that has the potential to help verify a card holder's identity and reduce fraud.

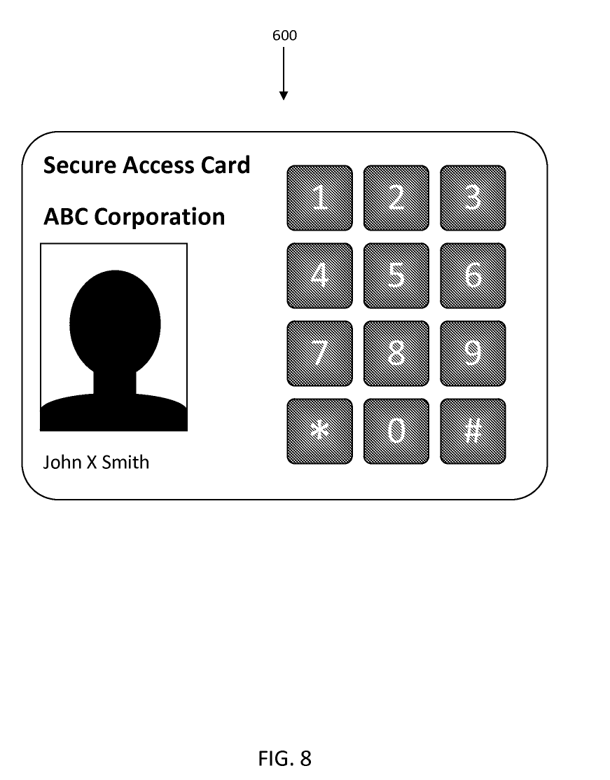

FIG. 8 shows a front view of a combination identity card and embodiment of a RFID keypad assembly of the present invention 600. The particular embodiment shown in FIG. 8 has a keypad with twelve keys. Such an embodiment may be used, for example, to enable a user to verify his or her identity during an identification check (and may also be used, for example, to enable an employer to verify an identity of an employee). In use, this general type of embodiment would allow a user to enter a (secret) personal identification code into a keypad built into the identity card at the time of an identity check. A nearby RFID reader, located at a door or other identity check point, for example, would receive any signal that is transmitted by the particular RFID keypad assembly. Once read, an associated information processing system may be used to determine if a particular code known to be associated with a particular individual has been entered. If so, this assists in verification of the individual. If not, it may provide an indication that the individual physically possessing the card is not the owner of the card. Code matching is done “off the card,” by an information processing system having an associated database, for example. As such, an embodiment of the type shown in FIG. 8 may be used in combination with an identity card to enhance office building security or access to secure commercial or other spaces, for example.

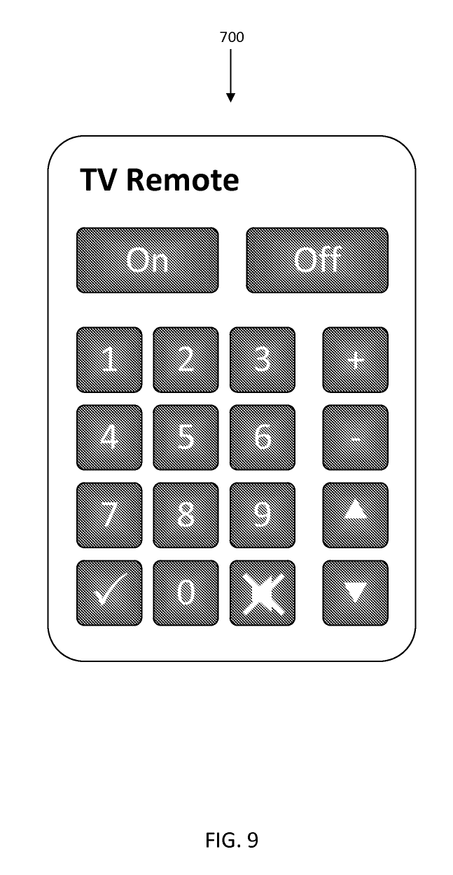

FIG. 9 shows a front view of a combination flat plastic card and embodiment of a RFID keypad assembly of the present invention 700. This particular embodiment represents a possible remote control for an electronic device, such as a television or radio, and has eighteen keys—two keys to control whether a target device is turned on or off, a numeric keypad having ten numbers, an enter key and a mute key, two keys to control volume, and two keys to enable scrolling through channels. Many variations of this type of embodiment are possible, using a different number of keys, different key labels and functions, different key configurations, different types of keys, and more, for example. In this particular remote control embodiment 700, a user would be able to actuate various one or more keys or input sequences to cause a desired effect, such as turning the target device on or off, raising or lowering the volume of the target device, or changing a channel on the target device, for example. Other functions are possible. Such a remote control device could be used to control any of a variety of target devices in a manner that is consistent with embodiments of assemblies and methods of the present invention, including but not limited to: televisions, radios, music players, stereo systems, consumer electronic devices, recording devices, cameras, computers, communications devices, lighting, security systems, environmental control systems, air conditioning systems, heating systems, machinery, equipment and retail displays.

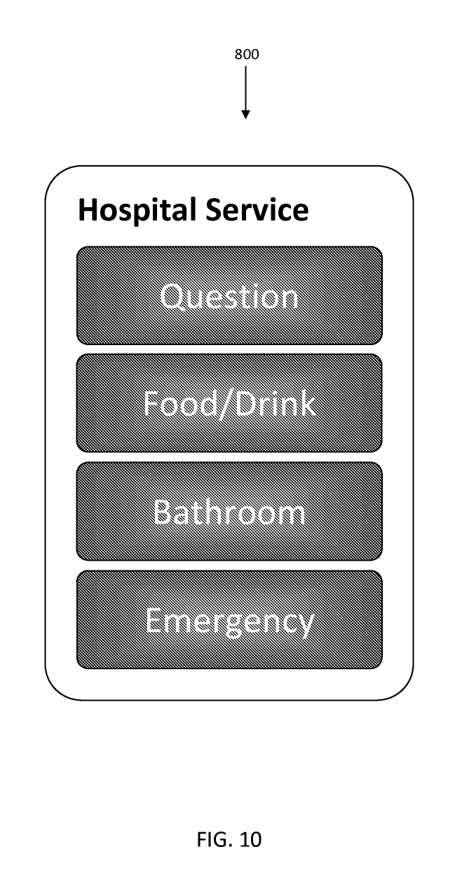

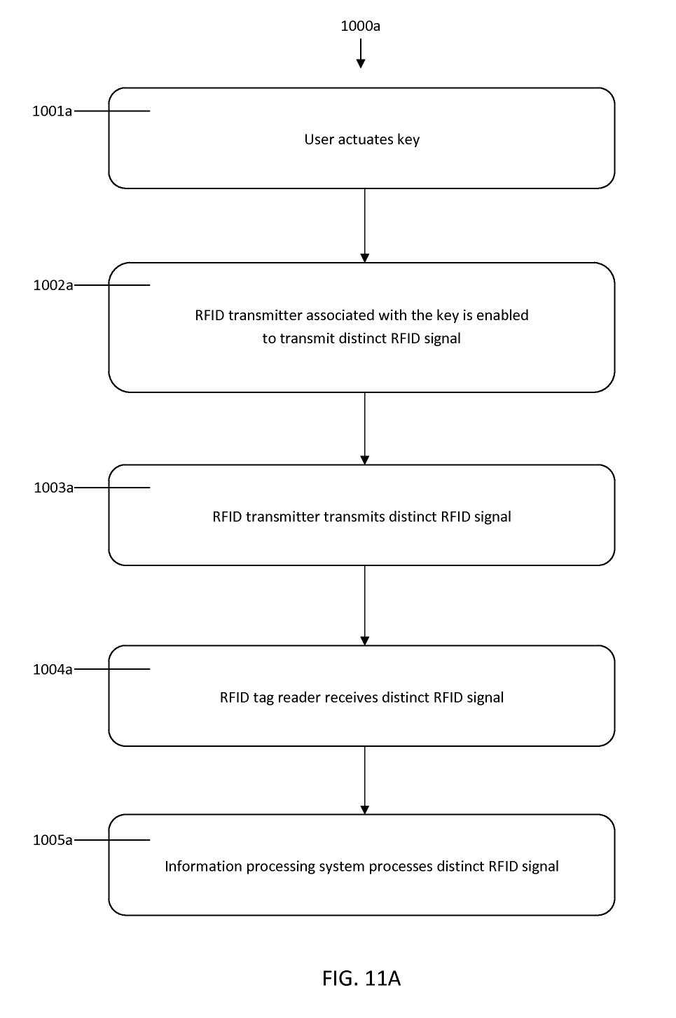

FIG. 10 shows a front view of a combination flat plastic structure and yet another possible embodiment of a RFID keypad assembly of the present invention 800. This particular embodiment represents a type of remote communications device that could be used in a hospital, nursing home or other long-term care setting, for example. Communications device 800 has four keys. A first key labeled “question” may be actuated by a user to communicate (via assemblies and methods of the present invention) a request for a nurse to call or visit a patient's room, for example. A second key labeled “Food/Drink” may be actuated by a user to communicate (via assemblies and methods of the present invention) a request for a food service attendant to call or visit a patient's room, for example. A third key labeled “Bathroom” may be actuated by a user to communicate (via assemblies and methods of the present invention) a request for a nurse to visit a patient's room for assistance going to the bathroom, for example. A fourth key labeled “Emergency” may be actuated by a user to communicate (via assemblies and methods of the present invention) that the user requires immediate attention, for example. These four keys are provided as examples of possible labels and commands that could be useful for such an embodiment of the present invention. Many variations are possible, including different keys, different number of keys, different key configurations, different key structures, and more, for example.

In general, FIGS. 7-10 show various possible representative embodiments of RFID keypad assemblies of the present invention. These examples demonstrate that embodiments of RFID keypad assemblies of the present invention may be designed and used in a many ways for a variety of practical applications.

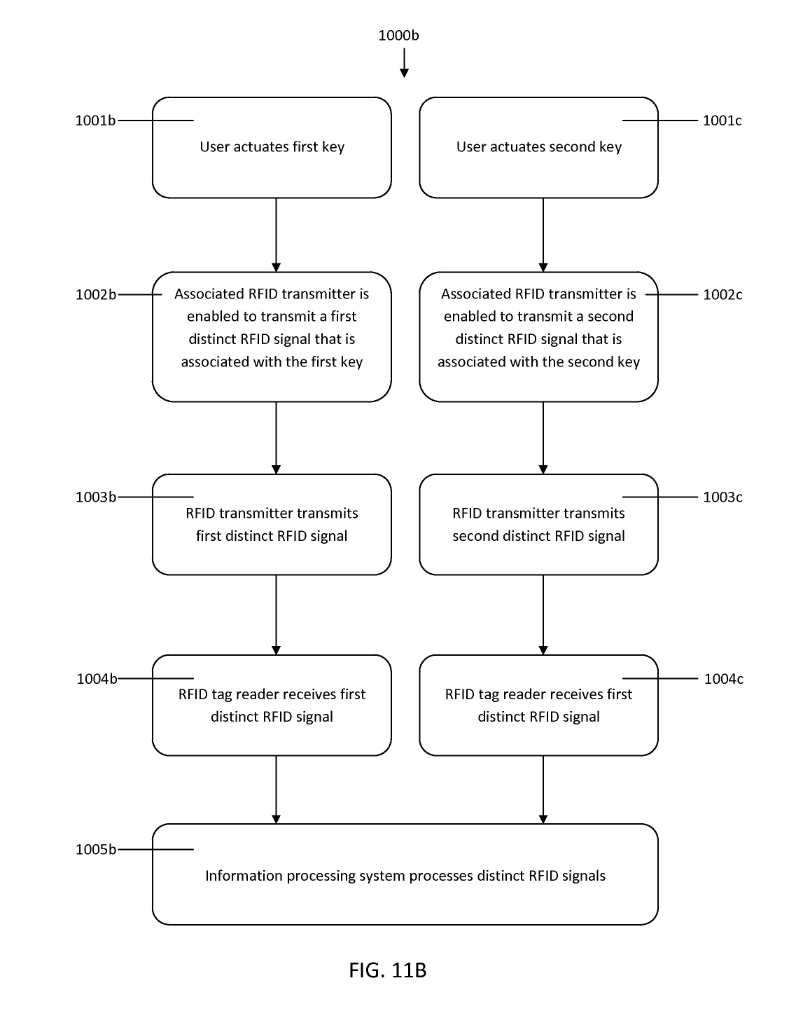

FIG. 11A shows a possible embodiment of a method of the present invention 1000a. In method 1000a, a key (of an embodiment of a keypad of a RFID keypad assembly of the present invention) is actuated 1001a. Key actuation 1001a enables an associated RFID transmitter to transmit a distinct RFID signal that is associated with the key that has been actuated 1002a. Such enablement may be triggering of an active transmission by an active RFID transmitter means, or by enabling a resonant transmission to be transmitted by a passive RFID transmitter means, for example. Next, a distinct RFID signal is transmitted 1003a, and the distinct RFID signal is subsequently received 1004a (by a RFID reader). The RFID reader communicates with an information processing system and the RFID signal is processed 1005a. Such processing may enable a determination of the particular key (associated with a particular device) was actuated, for example, which enables the information processing system to facilitate an action. Such an action may be, for example, an output signal that causes a person or target object to do something or to take notice. Method 1000a is one possible embodiment of a method of the present invention. Other possible embodiments may include variations to these steps, other steps, or sub-steps for example.

FIG. 11B shows another possible embodiment of a method of the present invention 1000b. In method 1000b, a first key (of a keypad of a RFID keypad assembly of the present invention) is actuated 1001b. Key actuation 1001b enables an associated RFID transmitter to transmit a first distinct RFID signal that is associated with the first key that has been actuated 1002b. Such enablement may be triggering of an active transmission by an active RFID transmitter means, or by enabling a resonant transmission to be transmitted by a passive RFID transmitter means, for example. Next, the first distinct RFID signal is transmitted 1003b, and the first distinct RFID signal is subsequently received 1004b (by a RFID reader). Then, a second key (of a keypad of a RFID keypad assembly of the present invention) is actuated 1001c. Key actuation 1001c enables an associated RFID transmitter to transmit a second distinct RFID signal that is associated with the second key that has been actuated 1002c, and which is distinct from the first distinct RFID signal. Next, the second distinct RFID signal is transmitted 1003c, and the second distinct RFID signal is subsequently received 1004c (by a RFID reader). The RFID reader communicates with an information processing system and the first and second distinct RFID signals are processed 1005b. Such processing may enable a determination of which particular key (associated with a particular device) was actuated, or a sequence of keys that have been actuated, for example. This enables the information processing system to provide an output which may, ultimately, facilitate an action. Such an action may be, for example, an output signal that causes a person or target object to do something or to take notice. Method 1000b is one possible embodiment of a method of the present invention. Other possible embodiments may include variations to these steps, the addition of other steps, or sub-steps for example.

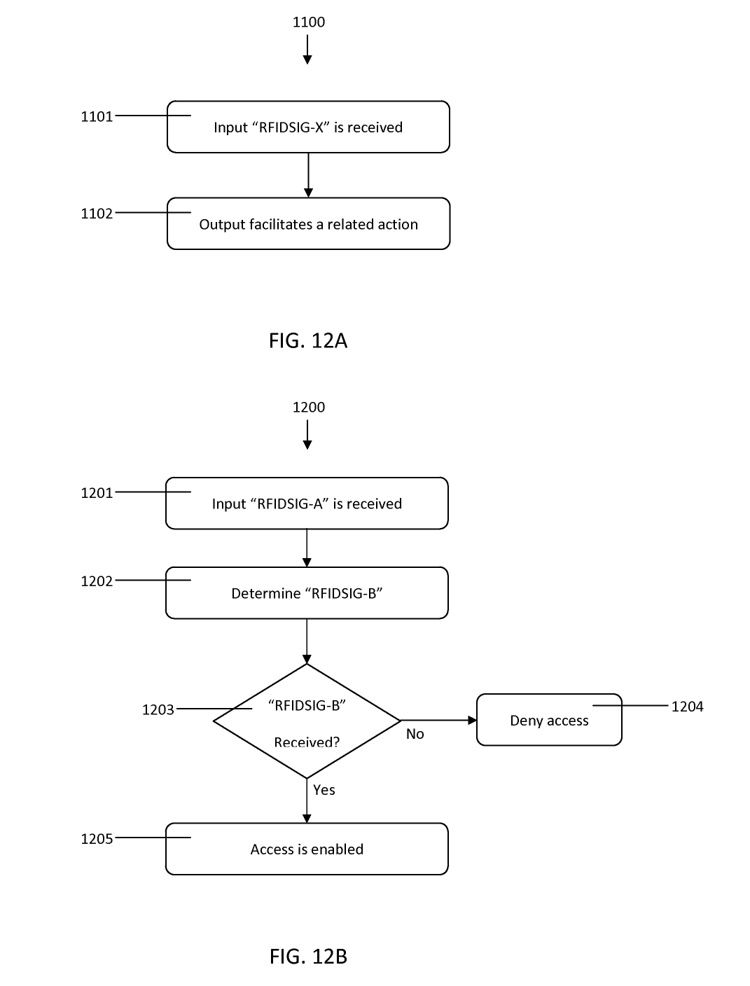

In particular, two processes relating to how an information processing system may work are shown in FIGS. 12A-B. FIG. 12A shows a process whereby an input indicates that a particular signal (“RFIDSIG-X” in this case) has been communicated to the information processing system 1101, and the information processing system then provides an output to facilitate a related action 1102. For example, the input RFIDSIG-X may relate to turning a particular electronic device on, in which case the output to facilitate a related action may be a signal (e.g., electronic signal) that causes the particular electronic device to turn on. FIG. 12B shows a method 1200 having slightly more complex logic relating to a sequence of inputs to an information processing system. This particular method 1200 involves an input consisting of two key actuations resulting in two signal transmissions that are sequentially communicated to an information processing system. Method 1200 involves the receipt of input “RFIDSIG-A” 1201 and a determination of an expected next input (RFIDSIG-B in this case) 1202. When the next input is received, method 1200 determines if the input is RFIDSIG-B. If so, access (e.g., to a physical space) is enabled. If not, access is denied. This method is presented as an example of logic that may be used by an information processing system of the present invention. Other logic may also be used to analyze individual and combination signal inputs to derive information from single or multiple key actuations of RFID keypad assemblies of the present invention, and to apply such information to facilitate certain actions or events.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

The techniques described above may be implemented, for example, in hardware, software tangibly embodied in non-transitory signals on a computer-readable medium, firmware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input and generating output. Suitable processors include, for example, both general and special purpose microprocessors. Generally, the processor receives instructions and data from a read-only memory and/or a random access memory. Storage devices suitable for tangibly embodying computer program instructions include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

What is claimed is:

1. A keypad assembly, comprising:
a plurality of keys;
a first RFID signal transmission means, associated with a first one of the plurality of keys, for transmitting a first RFID signal; and
a second RFID signal transmission means, associated with a second one of the plurality of keys, for transmitting a second RFID signal, wherein the first and second RFID signals are distinct from each other.

2. The keypad assembly of claim 1, wherein the first RFID signal transmission means comprises means for transmitting the first RFID signal in response to actuation of the first one of the plurality of keys.

3. The keypad assembly of claim 2, wherein the second RFID signal transmission means comprises means for changing a signal transmission state of the second RFID signal transmission means from a first state to a second state in response to actuation of the second one of the plurality of keys.

4. The keypad assembly of claim 3, wherein the first state comprises a state in which the second RFID signal transmission means is enabled to transmit the second signal, and wherein the second state comprises a state in which the second RFID signal transmission means is disabled from transmitting the second signal.

5. The keypad assembly of claim 3, wherein the first state comprises a state in which the second RFID signal transmission means is disabled from transmitting the second signal, and wherein the second state comprises a state in which the second RFID signal transmission means is enabled to transmit the second signal.

6. The keypad assembly of claim 1, wherein the first RFID signal transmission means and the second RFID signal transmission means are physically disjoint from each other.

7. The keypad assembly of claim 1, wherein the first RFID signal transmission means and the second RFID signal transmission means constitute a single physical transmission means.

8. The keypad assembly of claim 1, wherein the first key comprises a first physical key.

9. The keypad assembly of claim 1, wherein the first key comprises a first virtual key.

10. The keypad assembly of claim 1, wherein the first RFID signal differs in frequency from the second RFID signal.

11. The keypad assembly of claim 1, wherein the first RFID signal differs in amplitude from the second RFID signal.

12. The keypad assembly of claim 1, wherein the first key is mechanically linked to the first RFID signal transmission means.

13. The keypad assembly of claim 1, wherein the first key is electronically linked to the first RFID signal transmission means.

14. The keypad assembly of claim 1, wherein the first key is linked to the first RFID signal transmission means by means of a microprocessor.

15. The keypad assembly of claim 1, wherein the first RFID signal transmission means comprises a passive RFID transmitter.

16. The keypad assembly of claim 1, wherein the first RFID signal transmission means comprises an active RFID transmitter.

17. The keypad assembly of claim 1, wherein the first RFID signal transmission means comprises a semi-active RFID transmitter.

18. The keypad assembly of claim 1, wherein the first RFID signal transmission means comprises means for transmitting the first RFID signal concurrently with actuation of the first one of the plurality of keys.

19. The keypad assembly of claim 1, wherein the first RFID signal transmission means comprises means for transmitting the first RFID signal as a prolonged signal.

20. The keypad assembly of claim 1, wherein the first signal transmission means comprises means for transmitting the first RFID signal after elapse of a delay after actuation of the first one of the plurality of keys.

21. The keypad assembly of claim 1, wherein the first RFID signal transmission means comprises means for transmitting the first RFID signal repeatedly after actuation of the first one of the plurality of keys.

22. The keypad assembly of claim 1, further comprising an object coupled to the keypad assembly.

23. The keypad assembly of claim 22, wherein the object comprises an object selected from the group consisting of: a credit card, identification card, security card, and key card.

24. The keypad assembly of claim 1, further comprising:
a reader system comprising means for receiving the first and second RFID signals; and
a processing system comprising means for correlating the first RFID signal with a first value.

25. The keypad assembly of claim 24, wherein the processing system further comprises:
means for correlating the second RFID signal with a second value, wherein the first value is distinct from the second value.

26. The keypad assembly of claim 24, further comprising:
means for correlating absence of the second RFID signal with a second value, wherein the first value is distinct from the second value.

27. The keypad assembly of claim 24, wherein the processing system further comprises means for processing the first value to produce first output based on the first value.

28. The keypad assembly of claim 25, wherein the processing system further comprises means for processing the first value to produce first output based on the first value, and means for processing the second value to produce second output based on the second value, wherein the first output is distinct from the second output.

29. The keypad assembly of claim 25, wherein the processing system further comprises means for processing the first value and the second value to produce first output based on the first value and the second value.

30. A system comprising:
means for transmitting at least one interrogation RFID signal;
means for receiving a first RFID signal transmitted in response to the at least one interrogation RFID signal;
means for receiving a second RFID signal transmitted in response to the at least one interrogation RFID signal, wherein the first and second RFID signals are distinct from each other; and
a processing system comprising means for correlating the first RFID signal with a first value and means for correlating the second RFID signal with a second value.

31. The system of claim 30, wherein the processing system further comprises means for processing the first value to produce first output based on the first value and means for processing the second value to produce second output based on the second value, wherein the first output is distinct from the second output.

32. The system of claim 31, wherein the processing system further comprises means for providing a first action representing the first value and means for providing a second action representing the second value.

33. The system of claim 30, wherein the processing system further comprises means for processing the first value and the second value to produce first output based on the first value and the second value.

34. A method for use with keypad assembly, the keypad assembly comprising a plurality of keys, a first RFID signal transmission means associated with a first one of the plurality of keys, and a second RFID signal transmission means associated with a second one of the plurality of keys, the method comprising:
(A) using the first RFID signal transmission means to transmit a first RFID signal; and
(B) using the second RFID signal transmission means to transmit a second RFID signal, wherein the first and second RFID signals are distinct from each other.

35. The method assembly of claim 34, wherein (A) comprises transmitting the first RFID signal in response to actuation of the first one of the plurality of keys.

36. The method of claim 35, wherein (B) comprises changing a signal transmission state of the second RFID signal transmission means from a first state to a second state in response to actuation of the second one of the plurality of keys.

37. The method of claim 36, wherein the first state comprises a state in which the second RFID signal transmission means is enabled to transmit the second signal, and wherein the second state comprises a state in which the second RFID signal transmission means is disabled from transmitting the second signal.

38. The method of claim 36, wherein the first state comprises a state in which the second RFID signal transmission means is disabled from transmitting the second signal, and wherein the second state comprises a state in which the second RFID signal transmission means is enabled to transmit the second signal.

39. The method of claim 34, wherein the first RFID signal transmission means and the second RFID signal transmission means are physically disjoint from each other.

40. The method of claim 34, wherein the first RFID signal transmission means and the second RFID signal transmission means constitute a single physical transmission means.

41. The method of claim 34, wherein the first key comprises a first physical key.

42. The method of claim 34, wherein the first key comprises a first virtual key.

43. The method of claim 34, wherein the first RFID signal differs in frequency from the second RFID signal.

44. The method of claim 34, wherein the first RFID signal differs in amplitude from the second RFID signal.

45. The method of claim 34, wherein the first key is mechanically linked to the first RFID signal transmission means.

46. The method of claim 34, wherein the first key is electronically linked to the first RFID signal transmission means.

47. The method of claim 34, wherein the first key is linked to the first RFID signal transmission means by means of a microprocessor.

48. The method of claim 34, wherein the first RFID signal transmission means comprises a passive RFID transmitter.

49. The method of claim 34, wherein the first RFID signal transmission means comprises an active RFID transmitter.

50. The method of claim 34, wherein the first RFID signal transmission means comprises a semi-active RFID transmitter.

51. The method of claim 34, wherein (A) comprises transmitting the first RFID signal concurrently with actuation of the first one of the plurality of keys.

52. The method of claim 34, wherein (A) comprises transmitting the first RFID signal as a prolonged signal.

53. The method of claim 34, wherein (A) comprises transmitting the first RFID signal after elapse of a delay after actuation of the first one of the plurality of keys.

54. The method of claim 34, wherein (A) comprises transmitting the first RFID signal repeatedly after actuation of the first one of the plurality of keys.

55. The method of claim 34, further comprising:
(C) receiving the first and second RFID signals; and
(D) correlating the first RFID signal with a first value.

56. The method of claim 55, wherein (D) comprises:
correlating the second RFID signal with a second value, wherein the first value is distinct from the second value.

57. The method of claim 55, wherein (D) comprises:
correlating absence of the second RFID signal with a second value, wherein the first value is distinct from the second value.

58. The method of claim 55, wherein (D) comprises:
processing the first value to produce first output based on the first value.

59. The method of claim 58, wherein (D) further comprises processing the second value to produce second output based on the second value, wherein the first output is distinct from the second output.

60. The method of claim 58, wherein (D) comprises processing the first value and the second value to produce first output based on the first value and the second value.

61. A method comprising:
(A) Transmitting at least one interrogation RFID signal;
(B) receiving a first RFID signal transmitted in response to the at least one interrogation RFID signal;
(C) receiving a second RFID signal transmitted in response to the at least one interrogation RFID signal, wherein the first and second RFID signals are distinct from each other; and
(D) correlating the first RFID signal with a first value and correlating the second RFID signal with a second value.

62. The method of claim 61, further comprising:
(E) processing the first value to produce first output based on the first value; and
(F) processing the second value to produce second output based on the second value, wherein the first output is distinct from the second output.

63. The method of claim 62, further comprising:
(G) providing a first action representing the first value;
(H) providing a second action representing the second value.

64. The method of claim 61, further comprising:
(E) processing the first value and the second value to produce first output based on the first value and the second value.
